(19) United States
(12) Patent Application Publication
(10) Pub. No.: US 2008/0059845 A1
(43) Pub. Date: Mar. 6, 2008

(54) COMPUTER SYSTEM AND METHOD FOR OPERATING THE SAME

(76) Inventor: Yasunori YAMADA, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/831,117

(22) Filed: Jul. 31, 2007

(30) Foreign Application Priority Data
Sep. 4, 2006 (JP) 2006-239074

(51) Int. Cl. G06F 11/34; G06F 21/20

(52) U.S. Cl. 714/47; 726/4; 714/E11.02

(57) ABSTRACT

In a computer system, each personal computer includes a bootup management device managing the start operation thereof. The bootup management device excludes a personal computer that failed to start, and provides a user with another personal computer. The user operates the terminal device connected to a network, and can accomplish his work whichever personal computer is connected to his terminal device. An original bootup disk image is allocated to the personal computer determined to be abnormal and it is checked whether the personal computer can operate normally or not. If the personal computer can operate normally, this personal computer is registered in the bootup management device. If unable to operate normally, the personal computer is registered and notified as needing to be maintained.

### INCORPORATION BY REFERENCE

The present application claims priority from Japanese application JP2006-239074 filed on Sep. 4, 2006, the content of which is hereby incorporated by reference into this application.

### BACKGROUND OF THE INVENTION

1. Field of the Invention

The present invention relates to a computer system and more particularly to technology of operation, maintenance and use of the computer.

2. Description of Related Art

As related art, there is a client system of dual redundant configuration, in which the personal computers as operational objects are placed in a computer room to prevent risks of data leak and the personal computers are operated from external terminal devices under the condition that, when users perform business tasks with personal computers, (JP-A-2005-327233, for example).

Personal computers have conventionally been managed by the users, and if a trouble occurs, the trouble is rectified by the user on his or her own or by asking the Section in charge of computer management to repair the computer.

However, to allow a person charged with accomplishing the assigned task to concentrate on it and improve operational efficiency, it is desirable to ask the people in charge of equipment maintenance in Computer Management Department to maintain the personal computers.

Recently, there has emerged a system including personal computers operated by users, each formed on a circuit board and therefore called “blades”, or personal computers called “modules” in a box shape, and those personal computers are integrated in high density and arranged in a place accessible only by a system administrator, and this system is used via a computer network.

### SUMMARY OF THE INVENTION

Conventionally, the system administrator has had to manage only the server computer. However, when dual-redundant client computers are used, the system administrator is additionally charged with administrative and maintenance work of personal computers as operational objects; therefore, a question arises if there is any way of reducing an increased burden on the system administrator.

However, in the system disclosed in JP-A-2005-327233, for example, maintenance and management of computers (client devices) used by individual users is newly added to the task of the system administrator, who has only had to maintain and manage the computer (server device) shared with other users in existing work. It has become a serious problem how to decrease failures of the devices attending on conspicuously increasing numbers of users and devices to be managed.

On the other hand, progress has been made in a technology of a so-called dynamic allocation function of the individual data areas, in which if application software and an operating system are almost the same for each personal computer, by concentrating the areas, where user-specific information is stored, in a storage device connected via a network, it becomes possible for the users to edit and browse data and materials necessary for each individual's work by using any one optional personal computer without being bound by specific personal computers.

The object of the present invention is to provide a computer system capable of, based on the dynamic allocation function of the individual data areas as its backbone, immediately allocating another computer when the personal computer allocated to a user breaks down or fails to start, to enable the user to carry on his work, and on the assumption that the software is faulty in the computer that broke down or failed to start, reinstalling an operating system or an application program in that personal computer, deploying an image file installed in normal working order, and in case of a failure in the software, taking steps for the work to automatically come back to normal, calculating a frequency of occurrences of the failure and adding data into statistics, and thus providing a new criterion for preventive maintenance in the future.

Among the inventions disclosed in this application, the outline of a representative invention will be described briefly as follows.

According to the present invention, a computer system includes a plurality of personal computers for performing processes based on operations by the users through a plurality of terminal devices; a storage device for storing data owned by the plurality of users; and a bootup management device for, when the use of the terminal devices by the users is started, allocating the personal computers to the terminal devices, starting the allocated personal computers, and transferring data owned by the users from the storage device to the allocated personal computers to make data manipulable thereon, wherein the bootupmanagement device, when abnormality occurs in a personal computer, stores information about the occurrence of abnormality as management information, allocates another personal computer to the terminal device concerned, starts the allocated personal computer, then re-starts the personal computer determined to be abnormal to again confirm the condition of the faulty personal computer, and stores a confirmation result as management information in the storage.

According to the present invention, a method for operating computers in a computer system includes a plurality of personal computers for performing processes based on operations by a plurality of users through a plurality of terminal devices; a storage device for storing data owned by the plurality of users; and a starting management device for, when the use of the terminal devices by the users is started, allocating the personal computers to the terminal devices, starting allocated personal computers, and transferring data owned by the users from the storage device to the allocated personal computers to make data manipulable thereon, the method for operating the computers in the computer system comprises the steps of:

when abnormality occurs in a personal computer, storing information about the occurrence of abnormality as management information;

allocating another personal computer to the terminal device concerned;

starting the allocated personal computer;

re-starting the personal computer determined to be abnormal to again confirm the condition of the faulty personal computer; and

storing a result of the confirmation as management information.

### BRIEF DESCRIPTION OF THE DRAWINGS

FIG. 1 is a block diagram illustrating a system configuration of a computer system according to an embodiment of the present invention.

FIG. 2 is a diagram for explaining bootup checks and an live/dead decision method for personal computers necessary to operate a computer system according to the embodiment of the present invention.

FIG. 3 is a diagram illustrating an example of a bootup management table for personal computers, which is held in a bootup management device of the computer system according to the embodiment of the present invention.

FIG. 4 is a flowchart (part 1) showing a check sequence by the bootup management device when each user starts using the computer system according to the embodiment of the present invention.

FIG. 5 is a flowchart (part 2) showing a check sequence by the bootup management device when each user starts using the computer system according to the embodiment of the present invention.

### DETAILED DESCRIPTION OF THE INVENTION

An embodiment of the present invention is described in detail with reference to the accompanying drawings. Note that in all drawings illustrating the embodiment, the same components are designated in principle by the same symbols and repeated descriptions are omitted.

A computer system according to this embodiment of the present invention has a system including a client system where personal computer main bodies and terminal devices are connected in combination when they are used, each of the personal computer main bodies having an operating system and an application running therein and each of the terminal devices being used to remotely operate a personal computer. This computer system also has a control system having user-specific data stored in a place other than in the personal computers and terminal devices, and being capable of showing a user-specific data area by a virtual drive device or a symbolic link to make it available for use when a Start request arrives from a terminal device.

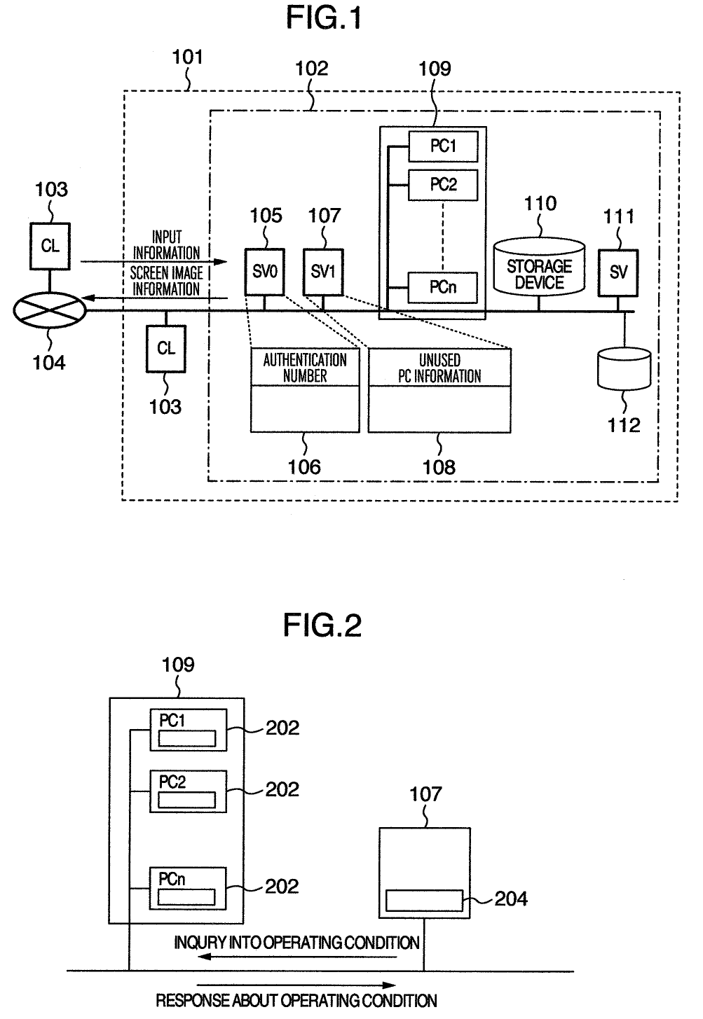

A system configuration of the computer system according to the embodiment of the present invention is described with reference to FIG. 1. FIG. 1 is a block diagram illustrating a system configuration of the computer system according to the embodiment of the present invention.

In FIG. 1, a computer system 102 includes a plurality of terminal devices (CL) 103 connected thereto, an authentication device (SV0) 105, a bootup management device (SV1) 107, personal computers 109 consisting of a plurality of personal computers, a storage device (SV) 110, and a data storage server 112.

A border line 101 divides between the inside of the organization where the computer system is located and a general network 104, along the border line there is normally a filter device called a firewall to restrict access by users.

Terminal devices 103 can send Connect requests inside and outside of the organization. A device that receives Connect requests is an authentication device 105 that examines if a Connect request that arrives from each terminal device has come from a legitimate terminal device by searching a database 106 containing authentication numbers, and issues a permission to connect when its identity has been authenticated.

A Connect permission is sent to a bootup management device 107 that manages the bootup of the personal computers 109.

The bootup management device 107 holds a bootup management table 108 as a list of unused-PC information showing the status of each personal computer updated dynamically inside the device 107, selects a personal computer suitable to be allocated, and starts the personal computer.

When starting the computer, the bootup management device 107 selects data owned by the user from the storage device 110, activates a virtual driver for the personal computer to be started, or establishes a symbolic link to a mount point to access this personal computer, and then sends the user a screen image indicating that a personal computer has been booted. The user, notified that the personal computer has been started, performs operations on data and applications necessary for the work by using a server device 111 and the data storage device 112, for example, connected to the network.

Description is now made of bootup checks and a live/dead decision as to the computer system according to the embodiment of the present invention by referring to FIG. 2. FIG. 2 is a diagram for explaining bootup checks and a live/dead decision method for personal computers necessary to operate a computer system according to the embodiment of the present invention.

Each unit of the group of personal computers 109 is equipped with a resident program 202 for a live/dead decision when the personal computer is started.

On the other hand, the bootup management device 107 keeps running a program 204 for periodic inquiries about the operating condition of personal computers of the personal computer group 109 as its managing objects.

In response to an inquiry from the program 204, each of the personal computers 109 sends back newly added various items of log information, or if they are not available, its own operating conditions (the CPU load factor, the free spaces of the memory and the hard disk, for example).

If there has been no response while waiting for a certain period of time after an inquiry was made, the bootup management device 107 decides that the personal computer in question is not operating normally, and shuts it down.

At this time, the bootup management device 107 selects out a free personal computer from the bootup management table 108, and starts the free personal computer.

Meanwhile, to the eye of the user of the terminal device 103, it looks as if the personal computer, which was in abnormal state, is re-started and an image that prompts the user to log in again appears on the screen of the terminal device.

Thus, as the bootup management device 107 selects and starts a free personal computer, it becomes possible for a user of the terminal device 103 to carry on his operation by using a healthy personal computer even when the personal computer that the user is using becomes abnormal and inoperable while it is in operation.

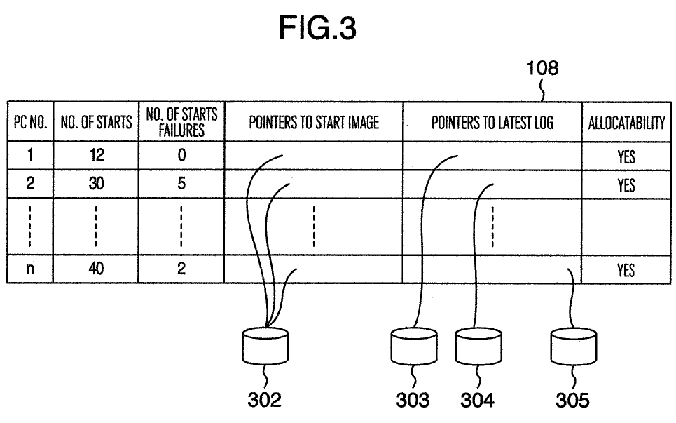

Referring to FIG. 3, description is made of the bootup management table of a personal computer, which is held in the bootup management device of a personal computer according to the embodiment of the present invention. FIG. 3 is a diagram illustrating an example of a bootup management table for personal computers, which is held in the bootup management device 107 of the computer system according to the embodiment of the present invention.

In FIG. 3, the main items stored in the bootup management table 108 include the names of personal computers, and the numbers of bootups and start failures, which indicate the operating condition, pointers 302 to the master of start images installed at bootup, and pointers 303, 304, and 305 to the latest log files of the personal computers.

In the example shown in FIG. 3, it is based on the assumption that an operating system and application software are loaded as bootup “image”. On the other hand, by using the installer, an installation sequence can be executed automatically to restore the personal computer to normal operation. Since the users data area is dynamically allocated to the personal computers, whether the devices can be allocated at the moment or not (already being used) are also recorded in the bootup management table 108 to prevent the same area from being allocated to another person. In the example of FIG. 3, with respect to “ALLOCATABILITY”, “YES” indicates “ALLOCATABLE”, and “NO”, though not shown in the drawing, indicates “NOT ALLOCATABLE”.

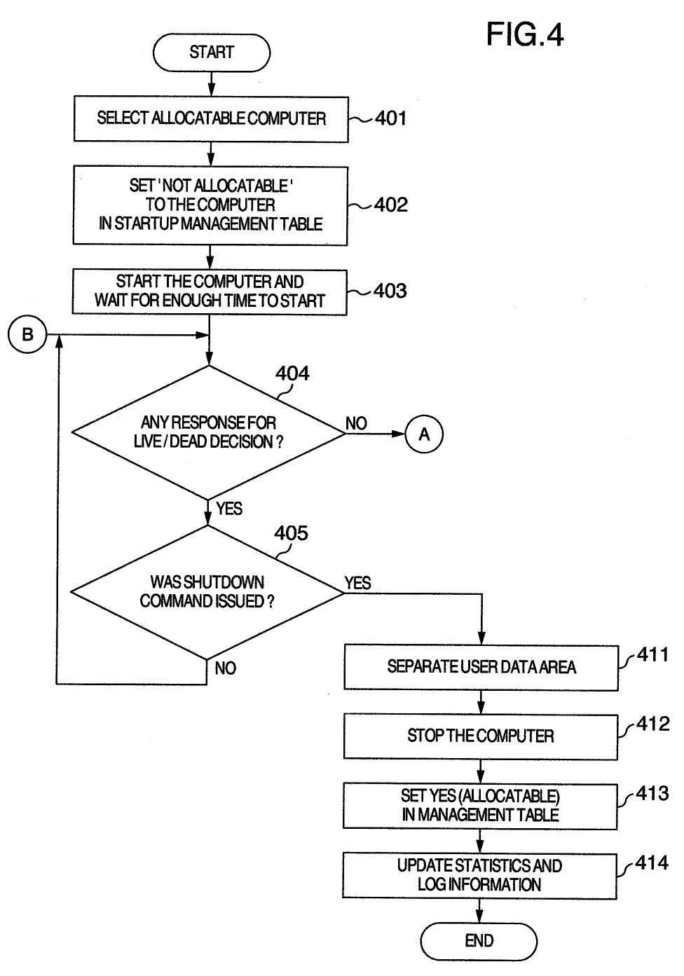

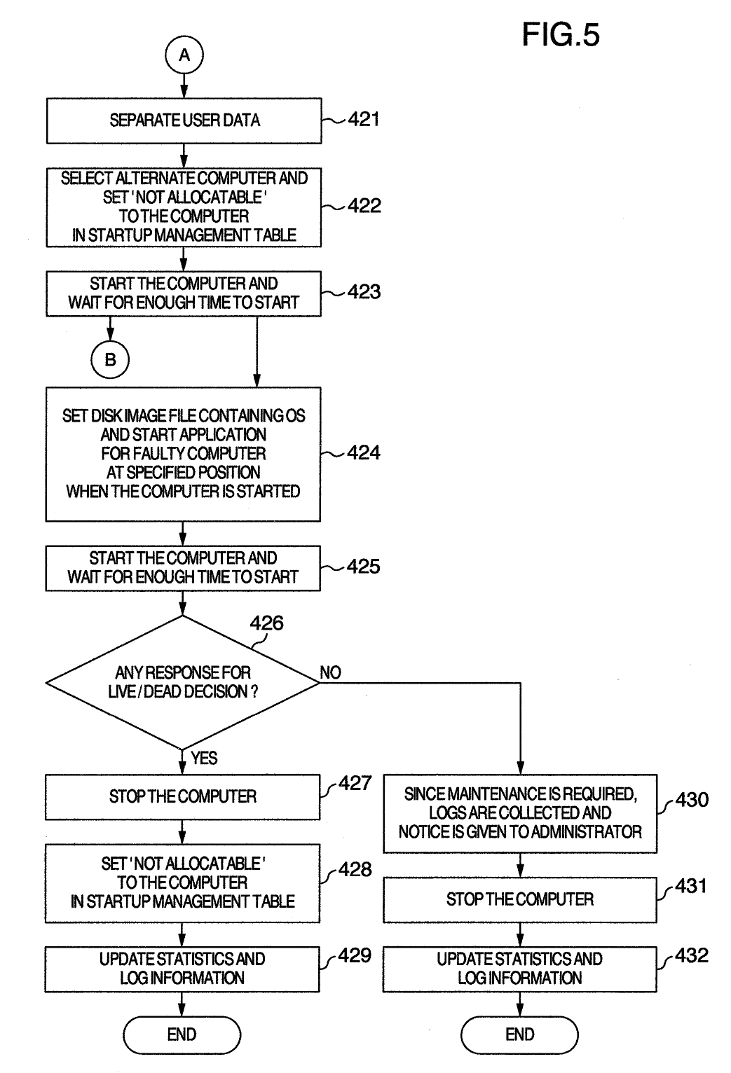

Referring to FIGS. 4 and 5, description will now be made of an example of a check sequence by the bootup management device when each user starts using the computer system according to the embodiment of the present invention. FIG. 4 is a flowchart (part 1) showing a check sequence by the bootup management device when a user starts using the computer system according to the embodiment of the present invention. FIG. 5 is a flowchart (part 2) showing a check sequence by the bootup management device when a user starts using the computer system according to the embodiment of the present invention.

The examples shown in FIGS. 4 and 5 are check sequences for one personal computer. Since the single bootup management device 107 manages many personal computers in the personal computer group 109, the check sequences of FIGS. 4 and 5 are executed in parallel.

On receiving a Start request from a terminal device 103, the bootup management device 107 selects out an allocatable personal computer out of the personal computer group 109 in the bootup management table 108 (step 401). This personal computer is entered as “Not allocatable” in the bootup management table (step 402).

Waiting is continued for enough time to allow an operating system and a live/dead decision program 202 shown in FIG. 2 to start running (step 403), and a live/dead decision is made to see whether the personal computer is operable or not (step 404). If a response arrives from the personal computer under test, the user, determining that the personal computer has started normally, issues a Shut-down command (step 405). Until a response arrives, the bootup management device 107 checks repeatedly at predetermined intervals for a response for the live/dead decision program and also for a reception of a Shut-down request.

When a normal Shut-down request arrives, the bootup management device 107 separates the user data area (step 411) from allocation and stops the personal computer in a normal end (step 412).

Further, the bootup management device 107 newly enters YES (Allocatable) for this personal computer in the bootup management table 108 (step 413), updates statistical information, such as the number of starts as shown in FIG. 3, and waits for a next Start request.

On the other hand, if a response to be used for a live/dead decision did not arrive during bootup, the bootup management device 107 separates the user data (step 421), selects and starts an alternate personal computer (step 422) to enable the user to carry on his work.

The bootup management device 107 enters in the bootup management table 108 that the newly selected personal computer is not to be allocated to any other terminal device (step 422).

The bootup management device 107 starts the selected, allocatable personal computer (step 423), and allocates a user data area again to enable the user to continue current work (corresponding to part (B) in FIG. 5).

On the other hand, with the faulty computer, in a bootup, the operating system and application software are either installed starting at a specified position, i.e. a position in a pointer 302 shown in FIG. 3 indicating the faulty computer, or a previously created image file is mapped (step 424), and a bootup procedure is performed and waiting takes place till the bootup is finished (step 425), checks again if the personal computer operates normally by the live/dead decision function (step 426), and if the personal computer can be started successfully, stops the personal computer (step 427), and sets a standby state to this personal computer in the bootup management table 108 (step 428).

Since this bootup is intended to check if a personal computer can be started after necessary software has been reinstalled, mapping of a user data area is not required.

At this time, if information about the frequency of recovery of this personal computer is stored as management information, such as the number of failures shown as an exemplary item in FIG. 3 (step 429), this is useful in terms of preventive maintenance in the future.

On the other hand, if an operating system and application software could not be reinstalled or if recovery to former condition could not be achieved even after the reinstallation had been completed successfully, since it is considered that ordinary maintenance by the administrator is required, logs are collected and the problem is notified to the administrator by e-mail, for example (step 430). The power supply to the computer at issue is switched off (step 431), and statistics and log information is updated (step 432) to be provided to the maintenance manager for reference.

As described, in this embodiment, many of the computers more often failed to start because of failures in software than in hardware. With this in mind, by attempting to recover the personal computer by reinstalling the operating system and application software that the user uses, it is possible to minimize manual labor by preventive maintenance and reduce total cost of ownership (TCO).

This makes it possible to provide data and materials as rules of thumb by which the administrator can pick out those computers that could be restored and yet are likely to break down again as well as those computers that could not be restored, and by which the administrator can issue a maintenance order. Accordingly, the administrator only needs to check faulty computers, which results in labor savings in maintenance and reductions in TCO.

Furthermore, it becomes possible to palliate recovery work by the terminal-device user who is forced to terminate the work although there is nothing wrong with the hardware of the personal computer.

The invention by the present inventor has been described in concrete terms by referring to an embodiment of the invention. The invention is not limited to the afore-mentioned embodiment, but, needless to say, various changes and variations may be made without departing from the spirit and scope of the invention.

This invention can be applied to general clerical processes in a wide range of industrial sectors, such as schools, government offices, trading firms, and manufacturing companies, and particularly to all business affairs, in which portable personal computers are likely to be used outside the companies. This invention is effective because it will reduce the number of disk image files to be managed where relatively uniform types of application software and middleware are used, such as in class rooms and in the similar Sections of the companies.

A brief description will be made of the effects obtainable by the representative invention among the inventions disclosed in the present application as follows.

According to the present invention, it is possible to reduce recovery work by the users and the administrator, who are compelled to break off the work although there is nothing wrong with the hardware.

Further, according to the present invention, materials can be provided which serve as rules of thumb, which enable the administrator to tell apart the personal computers that could not be restored or other computers that are likely to suffer frequent failures, and issue maintenance orders, and therefore the administrator has only to check the computers which do not operate normally, so that labor savings in management work can be achieved, and total cost ownership (TCO) can be decreased.

It should be further understood by those skilled in the art that although the foregoing description has been made on embodiments of the invention, the invention is not limited thereto and various changes and modifications may be made without departing from the spirit of the invention and the scope of the appended claims.

1. A computer system including a plurality of personal computers for performing processes based on operations by a plurality of users through a plurality of terminal devices; a storage device for storing data owned by the plurality of users; and a bootup management device for, when use of the terminal devices by the users starts, allocating the personal computers to the terminal devices, starting the allocated personal computers, and transferring data owned by the users from the storage device to the allocated personal computers to make data accessible thereon, wherein the bootup management device, when abnormality occurs in a personal computer, stores information about the occurrence of abnormality as management information, allocates another personal computer to the terminal device concerned, starts the allocated personal computer, then re-starts the personal computer determined to be abnormal to again confirm the condition of the faulty personal computer, and stores a confirmation result as management information in the storage.

2. The computer system according to claim 1, wherein the bootup management device detects if there is any functional failure in each of the plurality of personal computers, and if abnormality is detected, a boot image file of the operating system and the application is deployed on the personal computer detected as abnormal, and the frequency of decompression operations of the recovery file performed in the past is stored.

3. The computer system according to claim 1, further including an authentication device for authentication for use of the terminal device by receiving a digital signal containing information capable of being owned by the user from the terminal device when the user is going to operate the terminal device and collating the information with information about a legitimate user in possession thereof.

4. The computer system according to claim 3, wherein the bootup management device provides a use environment to a user classified by a usable kind of the personal computer, a usable server device through the personal computer, a usable software, and a possible period of time of use when the classified user meets the specified conditions and only when there is an allocated one of the personal computer operable by the classified user.

5. The computer system according to claim 1, wherein the system administrator of the computer system is provided with information stored by collecting part or all of information about a number of starts, a number of successful starts, a number of start failures, cumulative operating time, usability decision based on current condition, presence/absence of functional failures of each of the plurality of personal computers, and error logs of the operating system and the hardware.

6. A method for operating computers in a computer system includeing a plurality of personal computers for performing processes based on operations by a plurality of users through a plurality of terminal devices; a storage device for storing data owned by the plurality of users; and a starting management device for, when the use of the terminal devices by the users is started, allocating the personal computers to the terminal devices, starting allocated personal computers, and transferring data owned by the users from the storage device to the allocated personal computers to make data manipulable thereon, the method for operating the computers in the computer system comprises the steps of:
when abnormality occurs in a personal computer, storing information about the occurrence of abnormality as management information;
allocating another personal computer to the terminal device concerned;
starting the allocated personal computer;
re-starting the personal computer determined to be abnormal to again confirm the condition of the faulty personal computer; and
storing a result of the confirmation as management information.

7. The method for operating the computers according to claim 6, wherein the computer system detects if there is any functional failure in each of the plurality of personal computers, and if abnormality is detected, a boot image file of the operating system and the application is decompressed and restarted on the personal computer detected as abnormal, and the frequency of decompression operations of the recovery file performed in the past is stored.

8. The method for operating the computers according to claim 6, wherein the computer system performs authentication for use of the terminal device by receiving a digital signal containing information capable of being owned by the user from the terminal device when the user is going to operate the terminal device and collating the information with information about a legitimate user in possession thereof.

9. The method for operating the computers according to claim 8, wherein the computer system provides a use environment to a user classified by a usable kind of the personal computer, a usable server device through the personal computer, a usable software, and a possible period of time of use when the classified user meets the specified conditions and only when there is an allocated one of the personal computer usable by the classified user.

10. The method of operating the computers of the computer system according to claim 6, wherein the system administrator of the computer system is provided with information stored by collecting part or all of information about a number of starts, a number of successful starts, a number of failure to start, cumulative operating time, usability YES/NO decision based on current condition, presence/absence of functional failures of each of the plurality of personal computers, and error logs of the operating system and the hardware.
